(19) United States
(12) Patent Application Publication
(10) Pub. No.: US 2013/0292494 A1
(43) Pub. Date: Nov. 7, 2013

(54) GARDEN SPRAYER

(71) Applicant: Chin-Yuan Chen, Lu-Kang Town (TW)

(72) Inventor: Chin-Yuan Chen, Lu-Kang Town (TW)

(73) Assignee: SHIN TAI SPURT WATER OF THE GARDEN TOOLS CO., LTD., LU-KANG TOWN (TW)

(21) Appl. No.: 13/463,777

(22) Filed: May 3, 2012

(51) Int. Cl. A62C 31/00

(52) U.S. Cl. 239/442

(57) ABSTRACT

A garden sprayer includes a spraying cover and a guiding disk. A connecting end of the spraying cover is provided with a spindle and a guiding space surrounding the spindle. The guiding space is enclosed by a water-distributing ring provided with spraying heads. Each spraying head is provided with a sleeve at the connecting end. Each sleeve is provided with a guiding notch in communication with the guiding space. The guiding disk is fixedly mounted to the connecting end. The guiding disk is formed with a shaft portion and a penetration hole toward the spraying cover. The penetration hole is arranged to face one spraying head. The guiding space and the communication notches establish the communication between the spraying heads and the penetration hole. By this arrangement, the number of tiny spraying holes is increased, and the spraying effect of the whole garden sprayer is improved greatly.

### BACKGROUND OF THE INVENTION

1. Field of the Invention

The invention relates to a water sprayer, and in particular to a garden sprayer having an improved spraying effect.

2. Description of the Prior Art

Traditionally, a water sprayer is a device for spraying water. The sprayer can be used to clean and wash articles, water flowers or the like. In order to increase the efficiency of the water sprayer, reduce the amount of water used by the water sprayer, and apply to various conditions, the water sprayer is configured to have different spraying modes, so that a user can freely switch these predetermined spraying modes into a desired spraying mode. For example, these spraying modes include: strengthening/weakening of single water column gradually, changing the number of water columns, adjusting the range of conical spray, spraying mist or the like.

When a user is watering flowers, the user needs a great amount of spray but no strong water stream in order not to damage the flowers, branches and leaves. Thus, the user often switches the water sprayer into the mist mode. However, the spraying head of the existing water sprayer is provided with only one spraying hole of a tiny diameter. Thus, the amount of water spray is restricted by the diameter of the spraying hole. In other words, the conventional water sprayer has problems of small spraying area and insufficient spraying capacity. If the spraying hole is enlarged to increase the spraying capacity, the spraying effect of such an enlarged spraying hole will be unfavorably deteriorated. Therefore, another conventional water sprayer is proposed, in which a plurality of spraying holes is provided. However, such a water sprayer provided with multiple spraying holes still has the following problems. Since the water stream is distributed into a lot of spraying holes, each branch of water passing a spraying hole has uneven amount of water, which makes the water sprayer unable to spray uniformly. Further, each branch of water has a reduced water pressure due to its less amount of water, which affects the spraying effect greatly.

In view of the above, the present Inventor proposes a novel and practicable structure based on his expert knowledge and deliberate researches.

### SUMMARY

An objective of the invention is to provide a garden sprayer, which is capable of solving the above problems in prior art.

According to one feature of the invention, the garden sprayer includes a spraying cover and a guiding disk. The spraying cover is formed with a guiding space between a water-distributing ring and a spindle. The water-distributing ring is formed with a plurality of spraying heads each having a sleeve. Each sleeve is provided with a communication notch in communication with the guiding space. The water-guiding disk is provided with a post for allowing a water stream to flow in and guiding posts for dividing the water stream into branches. Open troughs, guiding notches and cut-out troughs together establishes the communication between the guiding space and the spraying heads. By this arrangement, the water stream can be uniformly distributed into the plurality of spraying heads, thereby increasing the spraying area and the spraying capacity.

According to another feature of the invention, the post of the guiding disk is provided with a restricting port, and the guiding post is provided with a cut-out trough. The restricting port and the cut-out trough guide the water stream to pour into the spraying heads of the spraying cover. The bottom surface of the sleeve of the spraying head is formed with an eddy trough and dividing grooves. When the water stream pours into the eddy trough, the water stream scatters radially to form an eddy. The water stream is further guided into the tiny spraying holes of each spraying head via the dividing grooves, thereby generating a better spraying effect. Further, these spraying heads simultaneously generate spray to thereby enhance the spraying effect of the whole garden sprayer.

Other objectives, advantages and novel features of the embodiment of the invention will be described in more detail with reference to the accompanying drawings.

### BRIEF DESCRIPTION OF THE DRAWINGS

FIG. 1 is a perspective view of the embodiment of the invention;

FIG. 2 is an exploded perspective view (I) of the embodiment of the invention;

FIG. 3 is an exploded perspective view (II) of the embodiment of the invention;

FIG. 4 is a schematic view showing the operation of the garden sprayer according to the embodiment of the invention;

FIG. 5 is a cross-sectional view showing the water stream in the guiding space of the embodiment of the invention;

FIG. 6 is a front view showing the water stream in the eddy trough of the embodiment of the invention; and

FIG. 7 is a perspective view showing the water spray of the embodiment of the invention.

### DETAILED DESCRIPTION OF THE PREFERRED EMBODIMENT

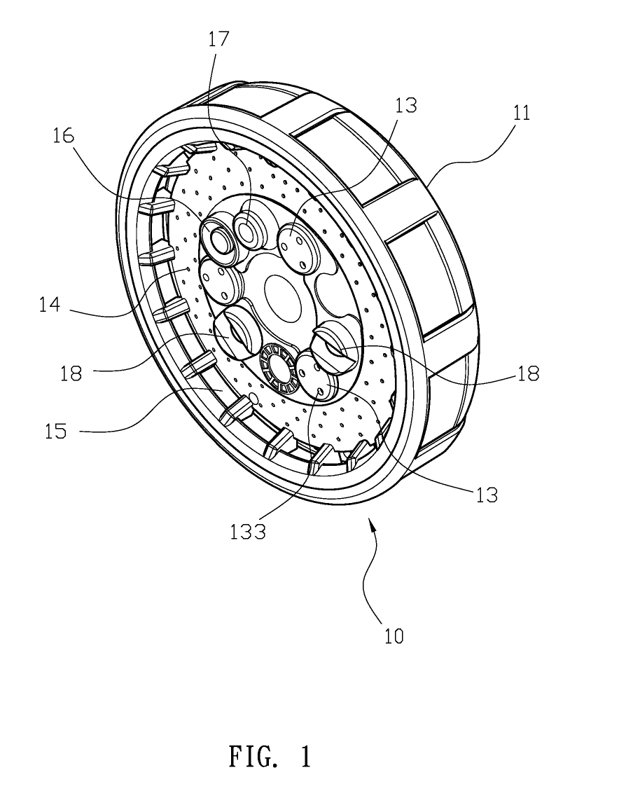

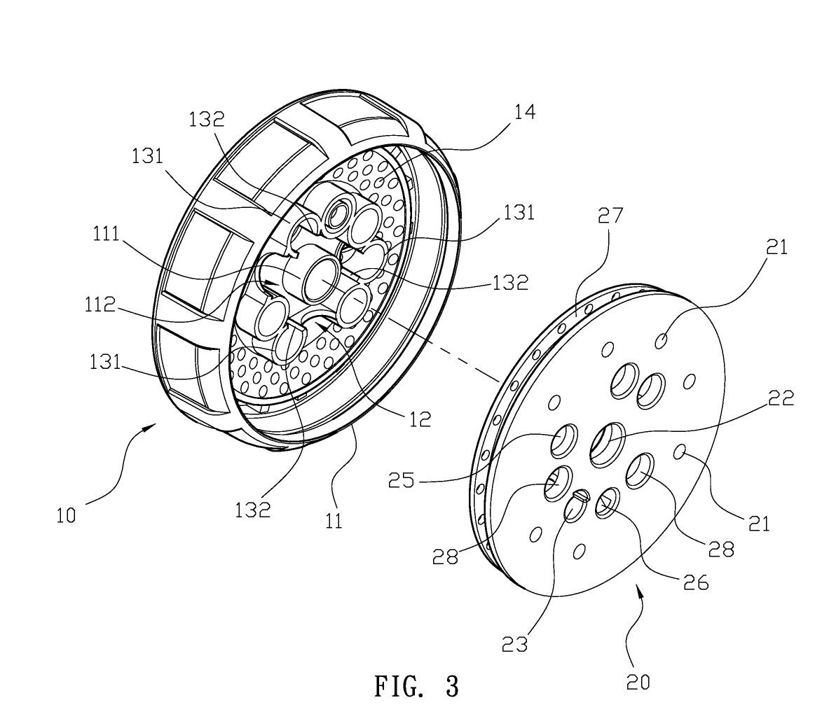

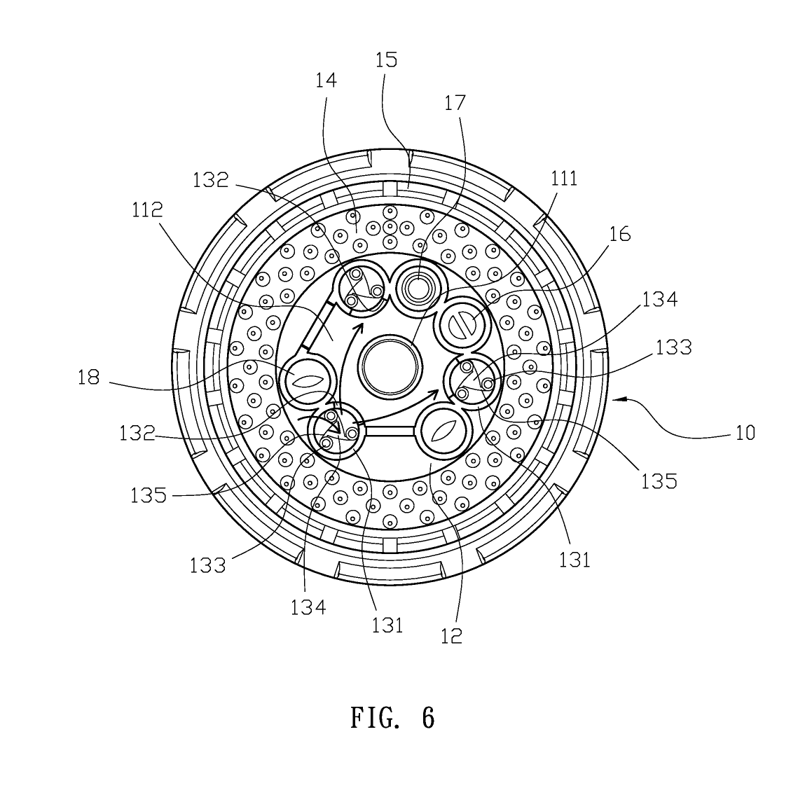

Please refer to FIGS. 1 to 4. The embodiment of the invention provides a garden sprayer including a spraying cover 10 and a guiding disk 20. The spraying cover 10 is provided with a connecting end 11 to be assembled with a water outlet of a gun body A. The center of the connecting end 11 is provided with a spindle 111 and a guiding space 112 surrounding the spindle 111. The guiding space 112 is enclosed by a water-distributing ring 12 provided with a plurality of spraying heads 13. Each spraying head 13 is provided with a sleeve 131 at the connecting end 11. Each sleeve 131 is provided with a guiding notch 132 in communication with the guiding space 112. Each spraying head 13 is formed with a plurality of tiny spraying holes 133. The tiny spraying holes 133 are arranged in a circle on each spraying head 13. The bottom surface of the sleeve 131 of each spraying head 13 is formed with an eddy trough 134 as shown in FIG. 6. Each eddy trough 134 is provided with dividing grooves 135 in communication with the tiny spraying holes 133 respectively.

The guiding disk 20 is fixedly mounted to the connecting end 11 of the spraying cover 10. The guiding disk 20 is provided with a plurality of positioning troughs 21 toward the gun body A. These positioning troughs 21 are configured to locate the rotation angles of the spraying cover 10 relative to the gun body A, so that the spraying cover 10 can be rotated to switch different spraying modes. The guiding disk 20 is formed with a shaft portion 22 and a penetration hole 23 toward the spraying cover 10. The penetration hole 23 is arranged to face one of the spraying heads 13. The guiding disk 20 is provided at the penetration hole 23 with a post 231 protruding toward the spraying head 13. The top end of the post 231 is provided with a restricting port 232 of a small diameter. The side wall of the post 231 is provided with an open trough 233 at a position corresponding to the communication notch 132 for communicating the restricting port 232 and the penetration hole 23. The guiding disk 20 is protruded with guiding posts 24 corresponding to the remaining spraying heads 13 other than the spraying head 13 facing the post 231. The guiding post 24 is formed with a cut-out trough 241 from top to bottom. The cut-out trough 241 is configured to communicate the tiny spraying holes 133 with the guiding space 112. The restricting port 232 cooperates with the cut-out trough 241 to uniformly divide the amount of water into each spraying head 13. The guiding space 112 cooperates with the communication notch 132 to communicate the spraying heads 13 with the penetration hole 23. With this arrangement, the amount of tiny spraying holes 133 is increased, and the spraying effect of the whole garden sprayer is improved greatly.

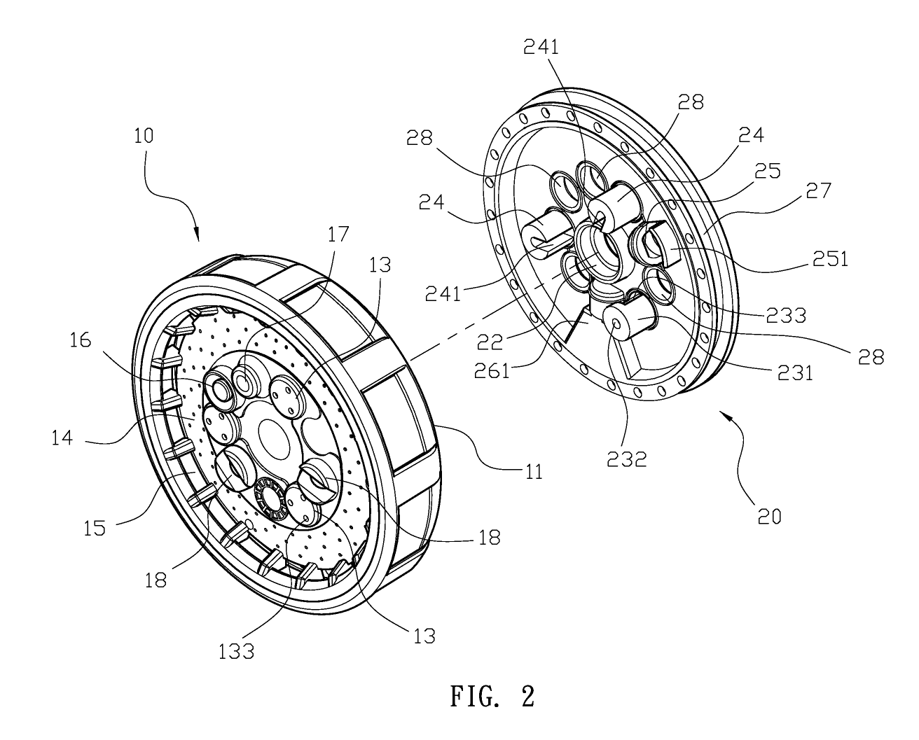

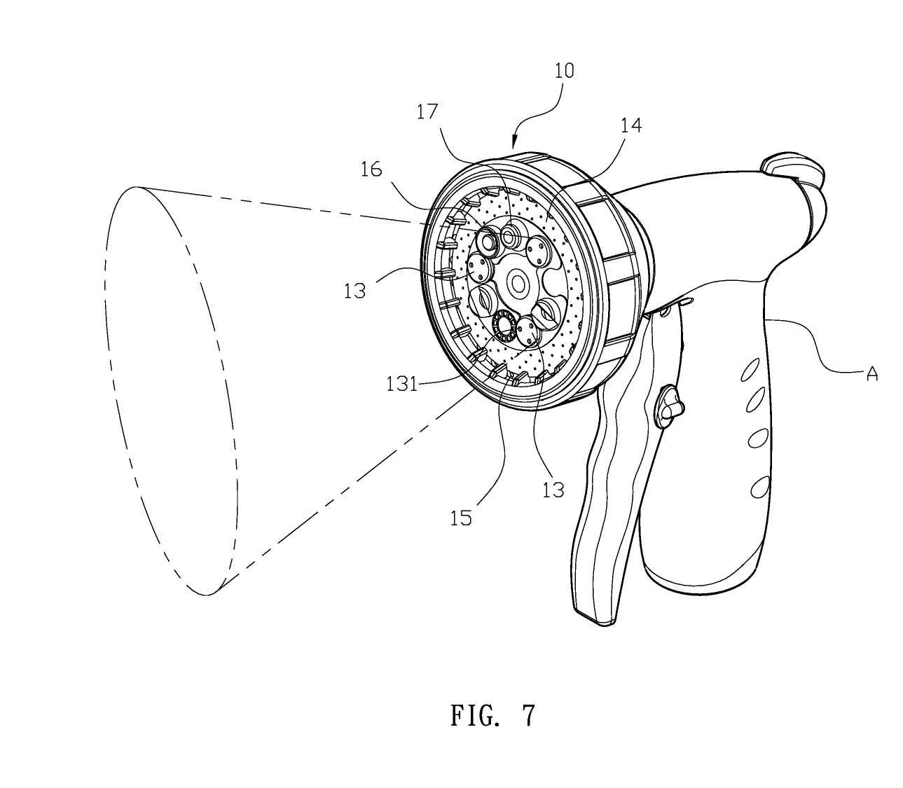

Please refer to FIGS. 2 to 7. The practical effect of the embodiment of the invention will be described as follows. The shaft portion 22 of the guiding disk 20 is put on the spindle 111 of the connecting end 11 of the spraying cover 10. Further, the post 231 and guiding posts 24 of the guiding disk 20 are inserted into the sleeves 131 of the spraying cover 10, so that the restricting port 232 of the post 231 and the cut-out troughs 241 of the guiding posts 24 are in communication with the tiny spraying holes 133 of the spraying heads 13 respectively. The open trough 233, the cut-out troughs 241, the communication notches 132, and the guiding space 112 together establish the communication between the spraying heads 13 and the penetration hole 23. In this way, the guiding disk 20 is fixedly combined with the spraying cover 10.

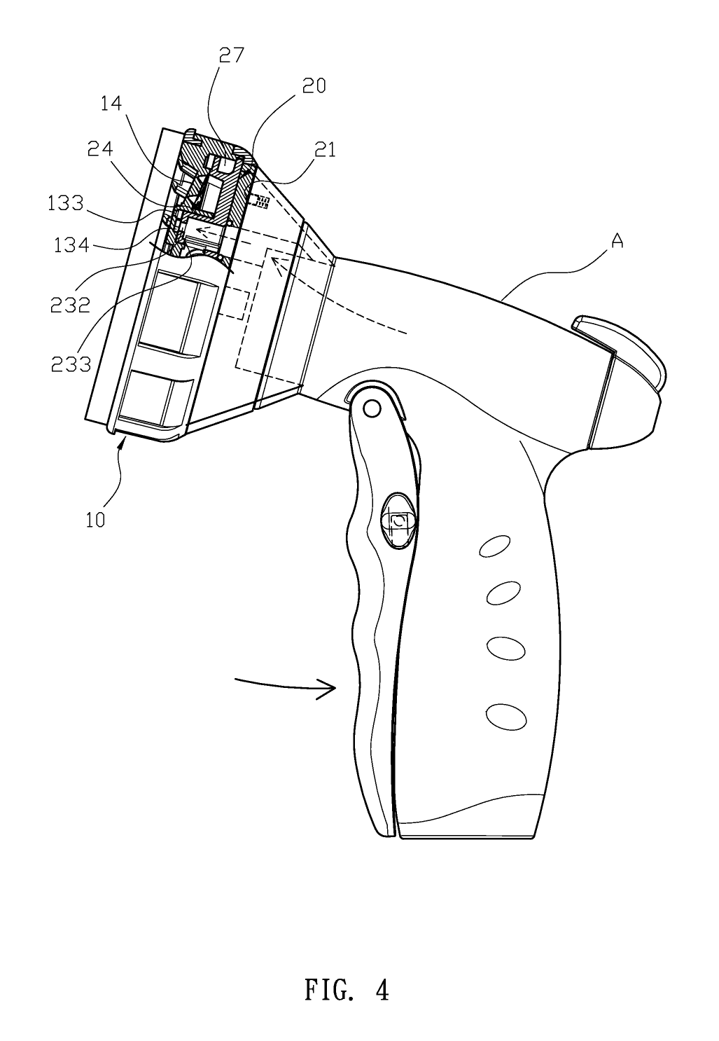

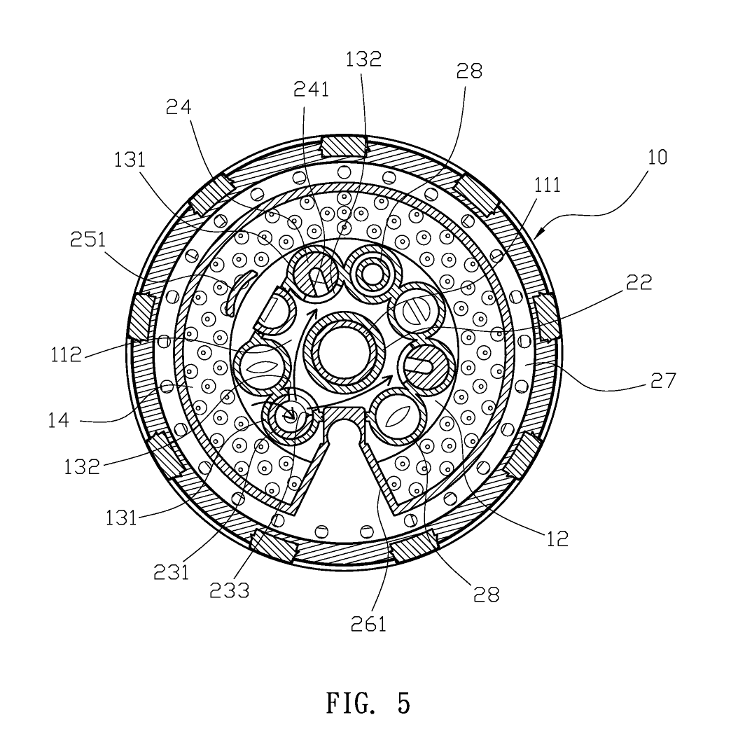

Further, as shown in FIG. 4, the connecting end 11 of the spraying cover 10 is mounted to the water outlet of the gun body A in such a manner that the guiding disk 20 is sandwiched between the spraying disk 10 and the gun body A. The spindle 111 of the spraying cover 10 is pivotally connected into a corresponding shaft of the gun body A, so that the spraying cover 10 and the guiding disk 20 can rotate simultaneously on the gun body A. The positioning troughs 21 of the guiding disk 20 are configured to locate the rotation angles of the spraying cover 10 relative to the gun body A, whereby the spraying cover 10 can be rotate to switch different spraying modes. When the penetration hole 23 of the guiding disk 20 is aligned with the water outlet of the gun body A, the water stream enters the post 231 via the penetration hole 23. As shown in FIG. 5, most of the water stream enters the open trough 233 of the post 231 and the communication notch 132 of the sleeve 131, and thus enters the guiding space 112 of the spraying cover 10. Then, the communication between the communication notches 132 and the cut-out troughs 241 allows the water stream to be uniformly distributed into the remaining spraying heads 13, so that each spraying head 13 has the same amount of water. As shown in FIG. 6, the restricting port 232 of the post 231 and the cut-out troughs 241 of the guiding posts 24 are configured to guide the water stream to pour into the eddy troughs 134 of the sleeves 131 respectively, thereby making the water stream to scatter radially to form an eddy. Further, the dividing grooves 125 are configured to guide the water stream into the tiny spraying holes 133 of the respective spraying heads 13. As a result, all the spraying heads 13 simultaneously generate spray to thereby increase the spraying area and the spray capacity. Therefore, the practicability of the embodiment of the invention is improved greatly.

Please refer to FIGS. 2 to 5 showing another operating state of the embodiment of the invention. When the spraying cover 10 rotates to another position, since a spraying hole zone 14 is formed on the outer edge of the water-distributing ring 12 of the spraying cover 10, and a through-hole 25 is provided on the guiding disk 20 at a position corresponding to the water-distributing ring 12. The through-hole 25 is configured as a curved channel in communication with the spraying hole zone 14. An outlet end of the through-hole 25 is provided with a blocking piece 251 for uniformly distributing the water stream in the spraying hole zone 14. By this arrangement, no excessive water pressure will be generated in the whole spraying hole zone 14, so that a better sprinkling effect is achieved. Please refer to FIGS. 2 to 5 showing a further operating state of the embodiment of the invention. The outer edge of the spraying cover 10 is formed inwardly with a spraying ring 15. The guiding disk 20 is provided with a guiding hole 26 at a position corresponding to the water-distributing ring 12. A sector channel 261 is provided on the outer edge of the guiding disk 20 to communicate with the guiding hole 26. The outer edge of the guiding disk 20 is formed with a water-entering ring 27 in communication with the spraying ring 15. When the spraying cover 10 rotates to the position of the guiding hole 26, the water stream flows through the sector channel 261, the water-entering ring 27 and the spraying ring 15, so that the spraying ring 15 can generate angular spray.

Please refer to FIGS. 2 to 5 showing still a further operating state of the embodiment of the invention. The spraying cover 10 is formed with a plurality of column heads 16, 17, 18 on the water-distributing ring 12. The guiding disk 20 is formed with a plurality of column holes 28 corresponding to the column heads 16, 17, 18 respectively. The column heads 16, 17, 18 have different outer profiles, thereby generating various shapes of water columns.

According to the above-mentioned of the structure, the embodiments of the invention have the advantageous features as follows.

(I) The spraying cover 10 is formed with the guiding space 112 between the water-distributing ring 12 and the spindle 111. The water-distributing ring 12 is formed with the spraying heads 13 each having a sleeve 131. Each sleeve 131 is provided with a communication notch 132 in communication with the guiding space 112. The guiding disk 20 is provided at positions corresponding to the sleeves 131 with the post 231 for allowing the water stream to flow in and the guiding posts 24 for dividing the water stream. By means of the open trough 233, the communication notches 132 and the cut-out troughs 241, the guiding space 112 is in communication with the spraying heads 13, so that the water stream can be uniformly distributed into the plurality of spraying heads 13, thereby increasing the spraying area and the spraying capacity.

(II) The post 231 of the guiding disk 20 is provided with the restricting port 232. The guiding post 24 is provided with the cut-out trough 241. The restricting port 232 cooperates with the cut-out trough 241 to guide the water stream to pour into the spraying heads 13 of the spraying cover 10. The bottom surface of the sleeve 131 of each spraying head 13 is formed with the eddy trough 134 and the dividing grooves 135. When the water stream pours into the eddy trough 134, the water stream scatters radially to form an eddy. The water stream is further guided by the dividing grooves 135 into the tiny spraying holes 133 of each spraying head 13, thereby generating a spraying effect. Further, these spraying heads 13 simultaneously generate spray, so that the spraying effect of the whole garden sprayer of the invention is enhanced greatly.

Although the invention has been described with reference to the foregoing preferred embodiment, it will be understood that the invention is not limited to the details thereof. Various equivalent variations and modifications can still occur to those skilled in this art in view of the teachings of the embodiment of the invention. Thus, all such variations and equivalent modifications are also embraced within the scope of the invention as defined in the appended claims.

What is claimed is:

1. A garden sprayer, comprising:
a spraying cover having a connecting end to be assembled with a water outlet of a gun body, a center of the connecting end being provided with a spindle and a guiding space surrounding the spindle, the guiding space being enclosed by a water-distributing ring provided with a plurality of spraying heads, each spraying head being provided with a sleeve at the connecting end, each sleeve being provided with a guiding notch in communication with the guiding space, each spraying head being formed with a plurality of spraying holes; and
a guiding disk mounted to the connecting end of the spraying cover, the guiding disk being formed with a shaft portion and a penetration hole toward the spraying cover, the penetration hole being arranged to face one of the spraying heads, the guiding space and the communication notches establishing communication between the spraying heads and the penetration hole.

2. The garden sprayer according to claim 1, wherein the guiding disk is provided at the penetration hole with a post protruding toward the spraying head, a top end of the post is provided with a restricting port, a side wall of the post provided with an open trough at a position corresponding to the communication notch for communicating the restricting port and the penetration hole, and the guiding disk is protruded with guiding posts corresponding to the remaining spraying heads other than the spraying head facing the post, the guiding post formed with a cut-out trough for communicating the spraying holes with the guiding space, the restricting port cooperating with the cut-out trough to uniformly divide water into each spraying head.

3. The garden sprayer according to claim 2, wherein the spraying holes are arranged in a circle on each spraying head, a bottom surface of the sleeve of each spraying head is formed with an eddy trough, each eddy trough is provided with dividing grooves in communication with the spraying holes respectively.

4. The garden sprayer according to claim 1, wherein the guiding disk is provided with a plurality of positioning troughs toward the gun body, the positioning troughs are configured to locate rotation angles of the spraying cover relative to the gun body, so that the spraying cover can be rotated to switch different spraying modes.

5. The garden sprayer according to claim 1, wherein an outer edge of the water-distributing ring of the spraying cover is formed with a spraying hole zone, a through-hole is provided on the guiding disk at a position corresponding to the water-distributing ring, the through-hole configured as a curved channel in communication with the spraying hole zone, and an outlet end of the through-hole is provided with a blocking piece for uniformly distributing the water in the spraying hole zone.

6. The garden sprayer according to claim 1, wherein an outer edge of the spraying cover is formed inwardly with a spraying ring, the guiding disk is provided with a guiding hole at a position corresponding to the water-distributing ring, the outer edge of the guiding disk is provided with a sector channel in communication with the guiding hole, and the outer edge of the guiding disk is formed with a water-entering ring in communication with the spraying ring.

7. The garden sprayer according to claim 1, wherein the spraying cover is formed with a plurality of column heads on the water-distributing ring, and the guiding disk is formed with a plurality of column holes corresponding to the column heads respectively, the column heads having different outer profiles to thereby generate various shapes of water columns.
